(19) United States
(12) Patent Application Publication
(10) Pub. No.: US 2008/0109510 A1
(43) Pub. Date: May 8, 2008

(54) Medicine container

(76) Inventors: Axel Gerlt, Furth (DE); Robert Kagermeier, Nurnberg (DE)

Correspondence Address: BRINKS HOFER GILSON & LIONE, P.O. BOX 10395, CHICAGO, IL, 60610, US

(21) Appl. No.: 11/978,390

(22) Filed: Oct. 29, 2007

(30) Foreign Application Priority Data
Nov. 3, 2006 (DE) DE102006052.007.6

(51) Int. Cl. B65D 83/04; G06F 3/14; G06F 15/16

(52) U.S. Cl. 709/201; 206/534; 715/273

(57) ABSTRACT

A medicine container is provided. The medicine container may include at least one closable compartment operable to accommodate a medicine; a memory operable to store data; and a display element including a digital paper operable to display medicine data.

This patent document claims the benefit of DE 10 2006 052 007.6 filed Nov. 3, 2006, which is hereby incorporated by reference.

### BACKGROUND

The present embodiments relate to a medicine container.

A medical therapy procedure may include a patient regularly taking a medicine at a particular time and in a particular quantity. The therapy is tailored on the basis of the effects of a medicine and any side effects that might occur. If the medicine is not taken at regular intervals or an incorrect dose is taken, tailoring of the therapy is much more difficult.

A hospital staff ensures that the medicine is taken by a patient in accordance with a doctor's specifications when the patient is being treated as an in-patient in a hospital. A patient who is treated by a practice doctor externally must themselves make sure that they take the medicine at the right time and in the right quantity.

When a patient has to take a number of medicines distributed over a day, at particular times, and in a predetermined quantity, it is difficult to take the medicines correctly. A patient who is being treated in a hospital is regularly reminded by the hospital staff to take his or her medicines. A patient being treated as an out-patient must remember to take the medicine themselves.

A medicine container may include a number of closable compartments for accommodating medicines and are designed for one day's ration of medicines. Each closable compartment has a label. The closable compartment serves as an orientation aid for the patient or for a member of the nursing staff looking after the patient. The medicine container is a purely passive device. Taking the medicines held in the medicine container correctly depends on whether the nurse or the patient thinks about taking the medicine at the correct time. Errors can occur in filling up the individual compartments of the medicine holder.

A doctor prescribes a medicine for a patient to take. The medicine is handed out to the patient in a medicine package by the doctor himself or by a pharmacist. The patient is informed by the doctor or the pharmacist at what times and in what doses the medicine is to be taken. Patients may also view the prescription slip, which is enclosed with the packaging, to find out at what times and in what doses they should take the medicine. With older patients, in particular, difficulties and irritations can arise in such cases.

Serious or even life-threatening damage to the health of the patient may occur if a medicine is not taken at the right time and in the correct dose or if the patient forgets to take the medicine altogether. The therapy may take longer or even have an unsuccessful outcome if a medicine is not taken at the right time and in the correct dose or if the patient forgets to take the medicine altogether.

### SUMMARY AND DESCRIPTION

The present embodiments may obviate one or more of the drawbacks or limitations inherent in the related art. For example, in one embodiment, a medicine container provides help to the person taking the medicine with regard to the time at which the medicine is to be taken and the dose.

In one embodiment, the medicine container includes at least one closable compartment that accommodates the medicine. A memory element may store medicine-related data. A display element based on digital paper may display the medicine-related data.

The medicine-related data stored in the storage element can be visualized on the display using digital paper, also called e-paper. The medicine-related data can be visualized on the display in a simple manner and in real time. Digital paper may be an energy-saving display of a foil-type character. In contrast to LCD displays, digital paper does not include liquid crystals. An overview of the different technologies for digital paper can be found in the article entitled “Digitales Papier (digital paper)” in the German magazine “c't—Magazin for Computer Technik”, 21/2006, pp. 228ff. Displays based on a digital paper are extremely energy-saving. Displays based on a digital paper require a very low amount of energy to change their display content. Displays based on a digital paper can retain the contents of the display without an energy supply after the display has been switched off. By comparison to LCD displays, displays based on a digital paper do not require backlights or polarizers. The displays based on a digital paper are easy to read, especially in bright daylight. Exemplary digital paper may include electronic ink, an electrochromic display, and a reflective e-paper display. The digital paper examples are based on different principles. Electronic ink is based on the principle of electrophoresis. Electrophoresis includes moving particles in the electrical field. Electrochromic displays include a current-controlled electron migration between two control electrodes. The current-controlled electron migration initiates a chemical process in a pixel cell with dye. Reflective e-paper displays change their display content through mechanical processes, for example, through a mirror modulation of incident light rays.

A display including digital paper may be thin, bendable, light and relatively low-cost to produce using print technology. A display based on a digital paper may be produced in any size and has outstandingly high contrast. The information and identification data shown on the display including digital paper can be maintained over long periods without any energy or with low power consumption. Accordingly, the energy requirement is low. Alphanumeric and geometrical forms may be shown on a black and white or a color display, which accordingly allow both a visual and also a machine detection of the identification data.

The memory element may store medicine-related data. The medicine-related data that is to be shown on the display may be prespecified. The medicine-related data may include the time at which the medicine is to be taken and/or the dose to be taken. The display may be used by the patient or the nursing staff to fill the individual compartments of the medicine holder. The display may serve as an individual check for when and in what amount a medicine is to be taken. Dividing up the medicine container into different compartments allows different pelleted medicines, which are to be taken at the same time, to be put into the same compartment. Pelleted medicines may be medicines in pill or capsule form.

In one embodiment, the digital paper includes an electrochromic display. An electrochromic display may be a display including a plate or foil-type carrier. The carrier includes electrically-conductive plastic and small spheres with dye particles, which react chemically to an electrical voltage (electrochromic effect) and which change their color through the application of a direct current.

A communication interface may be used to exchange medicine-related data. The exchange of medicine-related data takes place between the medicine container and a higher-ranking (control) unit. A communication interface may be electronic components that transmit data between the medicine container and the higher-ranking unit. The communication interface may be used to regularly update the data stored in the memory and to display the data. The medicine-related data can be updated depending on the progress of the therapy. The communication interface is provided, for example, by a radio connection.

In one embodiment, the communication interface for data exchange includes an RFID transponder. The memory element for storage of data is a component of the RFID transponder. The RFID transponder may be integrated into the medicine container, for example, by gluing it on. Because of the small dimensions, the geometry of the medicine container does not have to be modified. An RFID transponder includes a high storage capacity. The RFID transponder has a low susceptibility to faults and the option of fast updating and adding to the data stored on its RFID chip. In addition to medicine-related data, further data may be stored on the RFID chip. The further data may include patient data or similar data, for example.

Data may be exchanged with a data management system. A data management system may be a medical information system in which all data relating to a patient's illness and the therapy measures taken can be maintained (stored). A medical information system may include a client-server topology. Patient-related data may be entered or retrieved by a terminal or of a workstation computer which is connected to a computer for central data management. Information relating to medicines may be managed in the medical information system. The information relating to medicines may be transmitted to the medicine container by a communication unit assigned to the client. The medicine container may store the information relating to medicines in the memory element of the medicine container and display the information relating to medicines on the display element.

In one embodiment, the data management system generates a contents list for the individual compartments of the medicine container. The individual compartments, for a correct assignment, have either a time-of-day label such as “in the morning”, “at midday” or “in the evening” or they are provided with a number or with a time or day to identify them. The contents list may be used by a nurse or a patient to fill up the medicine container at the start of the day or on the previous day with medicine for a whole day. The contents list may be used to check and monitor the taking of the medicine at particular times by reading off the displayed information. Special instructions for taking the medicine, such as taking it with a liquid, for example, may be stored in the contents list.

In one embodiment, the medicine container includes a control unit that displays time information. The control unit is, for example, integrated into an RFID transponder in the form of an RFID chip. The control unit may display time information on the display element. The nurse or the patient may view information about the time at which the medicine is to be taken and information about the current time of day. The nurse or patient may use the information to determine whether it is time to take the medicines stored in the compartment.

In one embodiment, at least one actuating button is provided on the medicine container. The actuating button may, for example, be used to “scroll” in a contents list, which cannot be completely shown on the display element. In this “scrolling,” different subsections of the contents list are successively shown on the display element.

In one embodiment, the actuating button may be used to confirm filling or emptying of a compartment. The confirmation may subsequently be archived in the data management system. The confirmation data may be exchanged from the medicine container to the data management system. The confirmation data serves as a statement about the correct medication of the patient.

In one embodiment, the actuating button is a piezo key that supplies energy to the display element. An actuation of the piezo key may update the display or the medicine-related data via the communication interface. A separate power supply does not have to be provided for the medicine container.

In one embodiment, at least one cover has a piezo actuator or a polymer actuator for automatic opening of the cover. The automatic opening may be coupled to timing information. For example, only the compartment for which the medicines are to be taken at that point may be opened. The cover is opened, for example, using an actuation button.

The medicine container may include a warning element for outputting a warning. The warning element, for example, may flash the display on the display element or generate a beep. Each compartment may include an optical light-emitting element to indicate explicitly that the medicines contained in this compartment are to be taken. One or more warning elements may be used to encourage taking of the medicines at the correct time.

In one embodiment, the medicine container includes a power supply element that supplies electrical energy. The power supply element may include a solar cell, for example, a low-capacity battery, such as a foil battery or as a capacitor. Power supply elements may be small and can thus be easily attached either to the display element itself or to the medicine container. Power supply elements are cheap to manufacture. Alternatively, for example, an electrochromic display may be supplied with energy by a piezo button. The power supply element may be used, for example, to supply electrical power to the warning element(s) or to a communication interface with a high transmit and receive power.

In one embodiment, the medicine container is a retail package. A retail package may be a container or a packet in which there is a single type of medicine. The retail package may be used when the patient has to take care of their own correct medication. A pharmacist or doctor who gives the patient the medicine embodied as a retail package can prespecify a dose instruction for the patient via a communication interface by a data management system. The display element is attached to the medicine container, so that it cannot be lost. The patient may read through the dosing instructions shown on the display before taking the medicine and then follow these instructions. Accordingly, it is ensured, with older patients especially, that a medication is given at particular times and in a particular dose, since the patient may be reminded by glancing at the display element about the instructions for taking the medicine.

In one embodiment, the display element, the memory elements and further components, such as the RFID transponder, for example, or one or more actuation elements are applied to a carrier. The carrier may be a self-adhesive foil. The components for displaying and for storing data and for communication may be applied to the medicine container in a single operation in a simple manner. Such a carrier may be suitable for attaching to a medicine container, such as medicine packaging. Accordingly, older patients and those who tend to be forgetful, may be supported in taking the medicine at the right time and in the right quantity.

The present embodiments further relate to a method for displaying medicine-related data. A memory element may store the medicine-related data. A display element including a digital paper may display the data.

In one embodiment, a communication element exchanges data with a data management system.

The data exchange between the communication element and the data management system may take place bidirectionally. For example, the medicine-related data may be transferred from the data management system to the medicine container. In another example, information from the medicine container, such as a confirmation by an actuating button that a compartment has been emptied, can be transferred to the data management system. Accordingly, it can be detected, for example, whether and when a medicine has been taken. Conclusions may be drawn in turn from the confirmation about the progress of the therapy.

The communication between the communication element and the data management system may be wireless, for example, via a radio, acoustical or optical communication. However, the communication element may directly contact the data management system. For example, there may be a direct electrically-conductive connection between the communication element and the data management system.

With regard to the method the advantages mentioned in respect of the medicine container for the preferred embodiments are to be transferred equally to the claims directed to the method.

### BRIEF DESCRIPTION OF THE DRAWINGS

FIGS. 1a and 1b illustrate one embodiment of a top view of a medicine container,

FIG. 2 illustrates one embodiment of a second medicine container, and

FIG. 3 illustrates one embodiment of a third medicine container.

### DETAILED DESCRIPTION

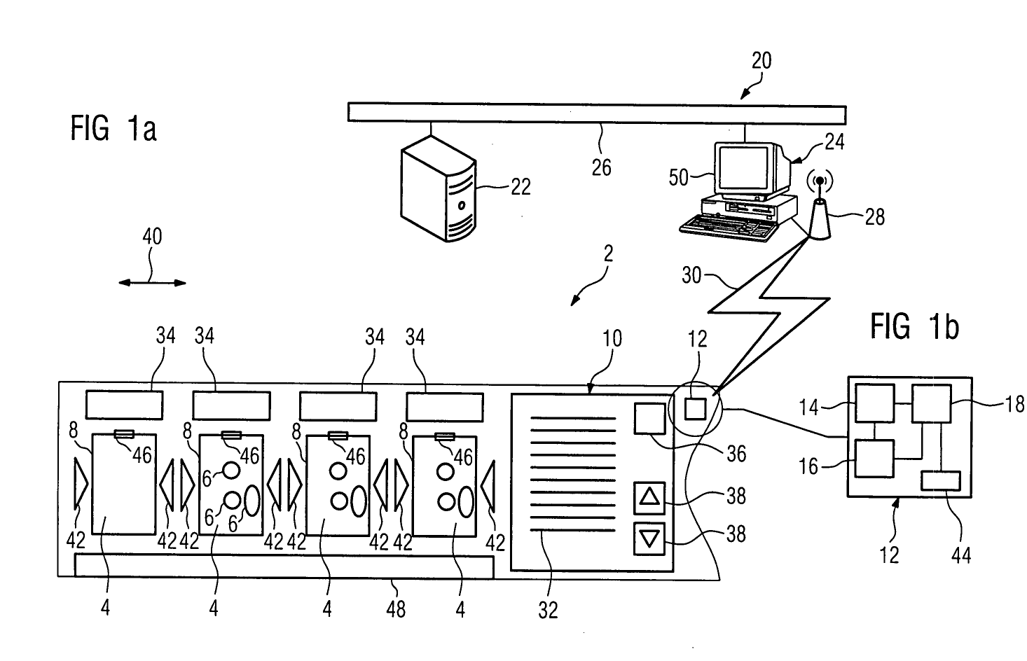

In one embodiment, as shown in FIG. 1a, a medicine container 2 includes four compartments 4 for accommodating medicines in the form of pelleted drugs 6. The pelleted drugs 6 may be pills or capsules. Each of the compartments 4 is closed off by a separate cover 8. The medicine container 2 includes a display element 10, such as an electrochromic display, and an RFID transponder 12.

The RFID transponder 12, as shown in FIG. 1b, includes a communication unit 14. The RFID transponder 12 includes a memory element 16 for storage of data and a control unit 18, such as an RFID chip, for scheduling.

The medicine container 2 may be used for medication of a patient, for example, in a hospital. A data management system 20, such as a medical information system, may be installed in the hospital. This data management system 20 includes a central server 22 and a number of clients 24, which are terminals or workstation computers. The client 24 may communicate with the server 22 via a data line 26. The clients 24 may be used to access the patient-related data stored in the server 22. The client 24 includes a communication unit 28 available locally. The communication unit 28 may be a wireless RFID reader.

The communication unit 28 of the data management system 20 and the communication unit 14 of the RFID transponder 12 form a communication interface 30 for bidirectional transmission of data between the data management system 20 and the RFID transponder 12.

The medicine container 2 may include the daily ration of medicine for a patient. The client 24 may generate medicine-related data with reference to the patient-related data. The medicine-related data may include the type of medicine, the time at which it is to be taken, and/or the quantity to be taken. The medicine-related data is transmitted by the communication interface 30 to the medicine container 2. The medicine-related data may be stored in the memory element 16 of the RFID transponder 12. The medicine-related data may be displayed as a contents list 32 on the display element 10 by the control unit 18.

Each of the four compartments 4 includes a label 34 with a specific legend. The label 34 can be a time interval or a time designation, such as “in the morning”, “at midday” or “in the evening”. The individual compartments 4 will be filled with the predetermined quantities of medicines on the basis of the contents list 32. The covers 6 will be closed. The filling is confirmed by an actuation element 36. The confirmation is documented and interpreted as correct filling of the medicine container 2. Two further actuation elements 38, such as pushbuttons, may be used with a very long contents list 32 to switch back and forth between the individual sections of text.

The completely filled medicine container 2 is subsequently handed to a nurse or to the patient for medication. At periodic intervals, a system timer integrated into the control unit 18 is read out and its timing information is compared with the timing information of the contents list 32. For each compartment there is a corresponding time interval in which the contents of the compartments 4 are to be taken by the patient. If the beginning of the time interval is reached, two light-emitting elements 42 arranged in a transverse direction 40 to the left and right of the compartment 4 begin to flash at intervals. The contents list 32 specifically for this compartment 4 may be shown. A beeper 44, which is activated by the control unit 18, may alert the nurse or the patient to the fact that the medicines in compartment 4 are to be taken by making a sound. The beeper may be an additional warning element.

A first press of the actuating button actuates a piezo element 46, via which the cover 6 belonging to compartment 4 is automatically opened. After the opening of the cover 6, it is possible for the medicines to be taken out of the compartment 4 and for the patient to take the medicine. After the compartment 4 has been emptied, the actuating button 36 is pressed once again so that the cover 6 of the compartment 4 is closed again by the piezo element 46. If the actuating button 36 is not pressed for a second time, a warning signal is output by the beeper 44 to warn the nurse or the patient to confirm that the medicine has been taken.

The medicine container 2 includes a solar cell 48 that supplies electricity to the medicine container 2. The solar cell 48 may include a strip.

The confirmations of the actuating button 36 may be read out and displayed on the display 50 of the client 24. For example, the RFID transponder 12 of the medicine container 2 may connect to the data management system 20 and exchange the confirmations via the communication interface 30.

A compartment 4, from which the medicines are to be taken out, can only be opened by the actuating button 36 at a particular point in time. Accordingly, an accidental emptying of one or other compartment 4 is securely avoided. In this way, an additional contribution to a secure execution of a medical therapy is achieved.

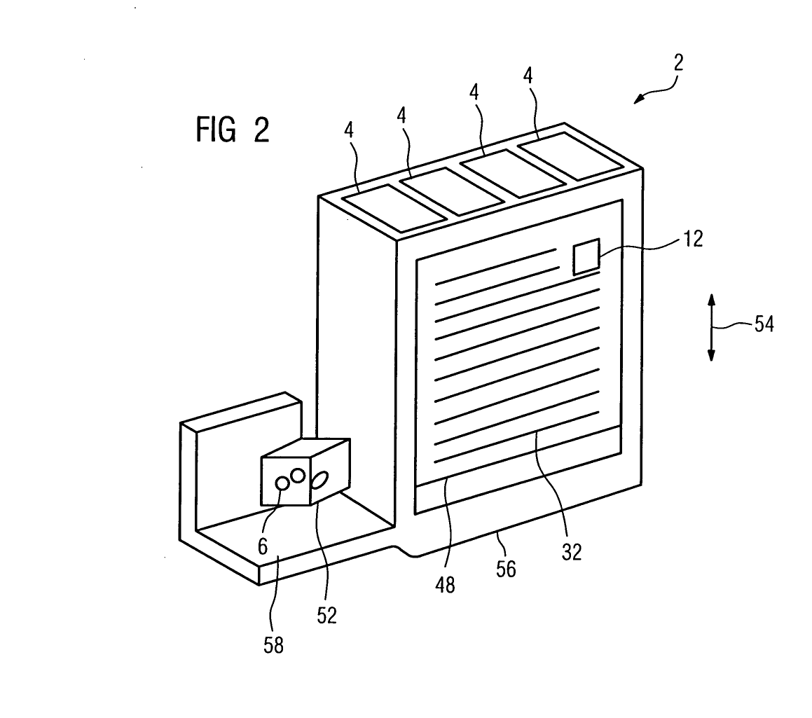

FIG. 2 shows an alternate embodiment of a medicine container 2. The medicine container 2 is a weekly dispenser. The weekly dispenser may include the medicine for a period of up to one week. Each of the four compartments 4 includes seven rectangular storage containers 52 stacked above one another for holding pelleted medicaments 6. A specific time interval is assigned to each of the compartments. The medicine container 2 includes a display element 10 and an RFID transponder 12. A power supply element, such as a foil battery, supplies electricity to the medicine container 2. The power supply element is arranged in the longitudinal direction 54 below the display element 10 on a side wall of the medicine container 2. A removal channel 58 for taking out the pelleted drugs 6 is disposed in the area of the floor 56 of the medicine container 2. As already described for the medicine container 2 from FIG. 1, the RFID transponder 12 communicates with the data management system 20 by the communication interface 30. The contents list 32 may be shown on the display element 10. The lowest container 52 of the corresponding compartment 4 is released in each case by a dosing system, for example, when the start of dosing time interval is reached. The medicine falls into a removal channel 58 from which it can be removed. The release of the container 52 is indicated by the beeper 44. In this way an automatic supply of a patient with tailored medicines is possible over a long period. The individual containers 52 may include graduated dose changes of individual medicines, so that the medical therapy for a period of up to one week can be predetermined in advance.

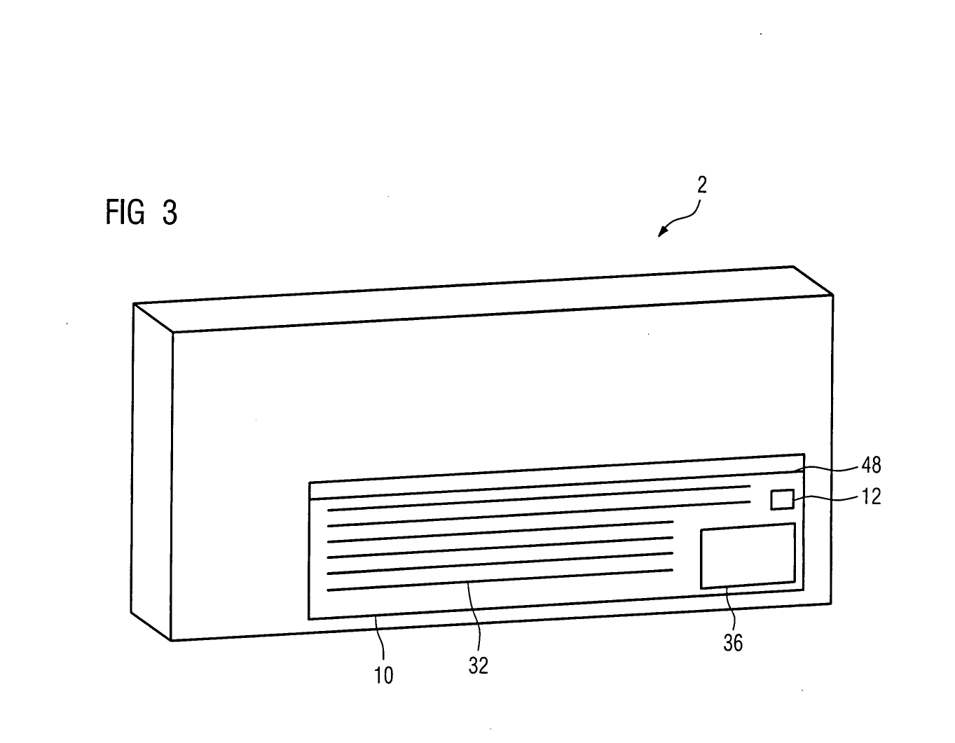

FIG. 3 shows a further alternate embodiment of the medicine container 2. The medicine container 2 may be a retail package, which includes a single type of medicine. Attached to one side of the medicine container 2 is the strip-type display element 10. The display element 10 is in the form of an electrochromic display. Arranged on the display 10 is the RFID transponder 12. The RFID transponder 12 communicates with the data management system 20 by the communication unit 14 of the RFID transponder 12. The client 24, as described in FIG. 2, may be used by a pharmacist who is handing out the medicine container 2 to the patient to transfer data that will be stored in the memory unit 16. The medicine-related data may be subsequently displayed in the form of a contents list 32 on the display element 10. The patient may confirm that the medicine has been taken using the actuating button 36, which is also arranged on the display element 10. The time at which the next medicine dosage is to be taken and the relevant dose can than be read from the display element 10. Tailored therapies may be predetermined. For example, a medicine with a particularly strong effect may be dispensed over the course of a predetermined period. The patient must only think about simply having to take the medicine. The patient reads the dose and the time at which the medicine is to be taken from the display element 10. The medicine container 2 has a foil battery embodied in the shape of a strip as its power supply element 48.

The display element 10, the RFID transponder 12, the actuating button 36 and the power supply element 48 may be applied on a carrier 60. The carrier 60 may be a self-adhesive label. The carrier 60 may be attached to the medicine container 2. This requirement arises, for example, with older patients with a tendency to forgetfulness who are to be assisted in taking their medicines at the right time and in the right quantity.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A medicine container comprising:
at least one closable compartment operable to accommodate a medicine;
a memory operable to store data; and
a display element including a digital paper operable to display medicine data.

2. The medicine container as claimed in claim 1, wherein the digital paper is an electrochromic display.

3. The medicine container as claimed in claim 1, comprising a communication interface operable to exchange of data.

4. The medicine container as claimed in claim 3, wherein the data is exchanged with a data management system.

5. The medicine container as claimed in claim 4, wherein the data management system includes an RFID transponder operable for the exchange of data.

6. The medicine container as claimed in claim 4, wherein the data management system is operable to generate a contents list of the at least one closable compartment.

7. The medicine container as claimed in claim 1, comprising a control unit operable to display time information.

8. The medicine container as claimed in claim 1, comprising at least one actuating button.

9. The medicine container as claimed in claim 8, wherein the at least one actuating button is operable to confirm a filling and/or emptying of the at least one closable compartment.

10. The medicine container as claimed in claim 8, wherein the actuating button is a piezo button of the display element for energy supply.

11. The medicine container as claimed in claim 1, wherein the at least one closable compartment includes at least one cover, the at least one cover including an actuator that opens the cover automatically.

12. The medicine container as claimed in claim 1, comprising a warning element operable to output of a warning message.

13. The medicine container as claimed in claim 1, comprising a power supply element operable to supply electrical energy.

14. The medicine container as claimed in claim 1, wherein the medicine container includes retail packaging.

15. The medicine container as claimed in claim 1, wherein the memory, the display element, or a combination thereof is applied on a carrier.

16. A method for displaying medicine container data, the method comprising:
acquiring medicine container data; and
displaying the medicine container data on a display element (including a digital paper.

17. The method as claimed in claim 16, comprising exchanging the medicine container information from a communication element to a data management system.

18. The method as claimed in claim 16 or 17, wherein the data exchange is bidirectional.

19. The medicine container as claimed in claim 11, wherein the actuator is a piezo actuator or polymer actuator.

20. The method as claimed in claim 16, wherein acquiring medicine container data includes retriving the medicine container data from a memory element.
